(19) United States
(12) Patent Application Publication
(10) Pub. No.: US 2009/0258104 A1
(43) Pub. Date: Oct. 15, 2009

(54) MOLD STRUCTURE FOR MANUFACTURING OF SECURING FILM

(75) Inventors: Suk-chul Lee, Gyeonggi-do (KR); Mi-young Kim, Gyeonggi-do (KR); Minoru Ueda, Osaka (JP)

Correspondence Address: THE NATH LAW GROUP, 112 South West Street, Alexandria, VA, 22314, US

(73) Assignee: Suk-chul LEE, Seongnam-si, Gyeonggi-do (KR)

(21) Appl. No.: 12/312,456

(22) PCT Filed: Nov. 13, 2006
(86) PCT No.: PCT/KR2006/004750

§ 371 Date: May 12, 2009

(51) Int. Cl. B29C 43/46

(52) U.S. Cl. 425/471

(57) ABSTRACT

The present invention relates to a mold structure for manufacturing a securing film, and in particular, to a mold structure for manufacturing a securing film by alternately stacking and coupling two thin circular plates having different diameters from each other and allowing a concave structure to be formed within a transparent synthetic resin film which is closely adhered to outer circumferential surfaces of the two plates according to a height difference between the outer circumferential surface of the plate having the larger diameter and the outer circumferential surface of the plate having the smaller diameter, and a securing film which is accurately manufactured by filling the concave structure of the transparent synthetic resin film with a colored ink and coating on the resulting outer circumferential surface a transparent synthetic resin film such as a polyethylene terephthalate (PET).

### TECHNICAL FIELD

The present invention relates to a mold structure for manufacturing a securing film, and in particular, to a mold structure for manufacturing a securing film by alternately stacking and coupling two thin circular plates having different diameters from each other and allowing a concave structure to be formed within a transparent synthetic resin film which is closely adhered to outer circumferential surfaces of the two plates according to a height difference between the outer circumferential surface of the plate having the larger diameter and the outer circumferential surface of the plate having the smaller diameter, and a securing film which is accurately manufactured by filling the concave structure of the transparent synthetic resin film with a colored ink and coating on the resulting outer circumferential surface a transparent synthetic resin film such as a polyethylene terephthalate (PET).

### BACKGROUND ART

In general, a securing film is referred to as a light control film, and is increasingly used for a private security purpose with respect to contents to be displayed on a display unit such as CRT, LCD, or the like because one's privacy recently becomes more important.

The securing film is typically configured such that a transparent layer and an opaque layer are alternately stacked in order to reduce a side viewing angle without interfering with a front sight of a viewer, and methods of alternately stacking such transparent and opaque layers are disclosed, for example, a method of manufacturing a louver film by alternately stacking a transparent material and an opaque layer and vertically cutting the material and the layer is disclosed in U.S. Pat. No. 2,053,173, and a method of manufacturing a plastic blind by alternately disposing and fixing a transparent film and a adhesive light shield film and vertically cutting the films is disclosed in U.S. Pat. No. 2,689,387.

In addition, it is required to form an opaque colored ink layer with an accuracy up to Dunit in order to guarantee about 30° of a viewing angle according to a distance between a depth of the opaque layer and an area of the transparent layer vertical to the opaque layer, so that an exposure technique which consumes high costs for such accurate processing and etches a layer for filling a colored ink is employed in recent years, however, it becomes more difficult for lights to reach a depth of the colored ink layer to be formed whenever a depth of the colored ink layer becomes greater, which causes the colored ink layer b be inclined toward its bottom side so that a viewing angle may be irregular due to inaccurate processing or the colored ink layer may not be formed over a predetermined depth.

### DISCLOSURE OF INVENTION

### Technical Problem

In order to solve the problems, it is an object of the present invention to provide a mold structure, which has two circular plates with different diameters from each other and alternately stacked on each other, and a transparent synthetic resin film wound on an outer circumferential surface of the stacked plates and closely adhered to the outer circumferential surfaces by a heat source to form a concave structure where an opaque layer to be filled with a colored ink is formed by the plate having the larger diameter and to form a transparent layer for guaranteeing a viewing angle by the plate having the smaller diameter so that the opaque layer can be accurately formed without limiting the depth of the opaque layer.

It is another object of the present invention to provide a securing film, which has a synthetic resin film with an accurate concave structure that is closely adhered to a mold structure composed of two circular plates and has a rectangular wave shape resulting from the opaque layer and the transparent layer, and fills the concave structure with a colored ink to coat an outer circumferential surface of the resin film with a transparent material such as PET, so that the size of the secure film can be freely changed and can be easily manufactured with a low cost and an accurate viewing angle.

### Technical Solution

One aspect of the present invention is to provide a mold structure for manufacturing a securing film, which includes: a plurality of first plates each having a penetrated thin circular plate at its center; a plurality of second plates each having a smaller diameter than the first plate and being disposed between the first plates, having a transparent synthetic resin film formed in a concave structure where a colored ink layer is to be formed by the first plates protruded outward due to a difference in diameter between the first and second plates, and having penetrated circular thin plates at respective centers; and a rotational axis fitted into the penetrated portions of the first and second plates.

In some embodiments, the rotational axis may have a guiding portion protruded on one side of the outer circumferential surface, and a guiding hole corresponding to the shape of the guiding portion may be penetrated at centers of the first and second plates.

In other embodiments, the first and second plates may have air holes closely adhered to the first and second plates for completely exhausting an internal air between the first and second plates at positions corresponding to each other when the first plate and the second plate are alternately coupled to the rotational axis.

In yet other embodiments, a support plate supporting the outermost plate and for preventing the plate from being deviated, and a bolt coupling unit for coupling the support plate with the bolt may be further included after the first and second plates are fitted into the rotational axis.

In still yet other embodiments, the first and second plates are made from a Steel Use Stainless (SUS).

In other embodiments, the first plate may have a diameter of 300 mm and the second plate may have a diameter of 299.85 mm so that a depth of the concave structure having the colored print layer may be 0.075 mm which is a difference in height between the first and second plates.

In yet other embodiments, the first plate may have a diameter of 20 D, the second plate may have a diameter of 50 to 500 D so that a width of the colored ink layer may be 20 D and a width of the transparent layer may be 50-500 D, which allows various viewing angles to be implemented.

Another aspect of the present invention is to provide a securing film using a mold structure, which includes: a colored ink layer which is opaque and formed by filling a concave structure of a transparent synthetic resin film manufactured by the mold structure with a colored ink; and a transparent layer formed of a transparent synthetic resin film which coats upper and lower parts of the synthetic resin film filled with the colored ink.

### Advantageous Effects

According to the present invention as configured above, an accurate concave structure can be easily formed in a transparent synthetic resin film by means of two plates having different diameters from each other, so that an accurate viewing angle of a securing film can be implemented without limiting a depth of an opaque layer.

In addition, a securing film capable of guaranteeing an accurate viewing angle can be manufactured with a low cost by means of a mold structure composed of two plates having different diameters from each other, and mechanical manufacturing and extensiveness can be facilitated by increasing the number of the circular plates so that the size of the securing film where an opaque layer and a transparent layer are variously formed can be freely adjusted.

### BRIEF DESCRIPTION OF THE DRAWINGS

FIG. 1 is a diagram illustrating a plate coupling configuration for a mold structure for manufacturing a securing film in accordance with the present invention.

FIGS. 2 and 3 are front diagrams illustrating a first plate and a second plate of a mold structure for manufacturing a securing film in accordance with the present invention.

FIG. 4 is a diagram illustrating a configuration of a rotational axis having a guide portion in accordance with the present invention.

FIG. 5 is a diagram illustrating a configuration of a rotational axis coupled with a first plate and a second plate in accordance with the present invention.

FIG. 6 is a front diagram illustrating a mold structure for manufacturing a securing film where a first plate and a second plate are stacked in accordance with the present invention.

FIG. 7 is a diagram illustrating a transparent synthetic resin film coupled to a mold structure in accordance with the present invention.

FIG. 8 is a diagram illustrating a configuration of a synthetic resin film separated from a mold structure in accordance with the present invention.

FIG. 9 is a diagram illustrating a configuration of a securing film manufactured by a mold structure in accordance with the present invention.

### BEST MODE FOR CARRYING OUT THE INVENTION

Hereinafter, preferred embodiments of the present invention will be described in detail with reference to accompanying drawings.

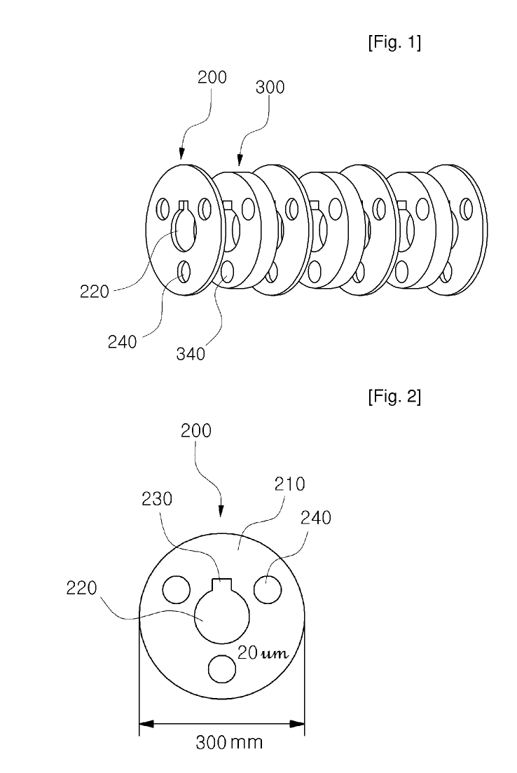

A mold structure for manufacturing a securing film according to the present invention includes a plurality of first plates 200 composed of respective thin circular plates, a plurality of second plates 300 alternately stacked and coupled between the first plates and composed of circular plates having a smaller diameter than the first plates, and a rotational axis 400 matching a center of the first plate with a center of the second plate for fixing the first and second plates as shown in FIG. 1.

The first plates 200 are composed of a plurality of thin circular plates 210 having a constant diameter, and a penetrating hole 220 for fitting into the rotational axis 400 is formed at a central portion of the circular plate as shown in FIG. 2. In addition, a guiding groove 230 allowing a guiding portion 410 which will be described later to be easily fitted into the rotational axis is preferably formed at one portion of the penetrating hole.

A plurality of air exhaust holes 240 for exhausting an internal air between the plates outward and for closely adhering to the plates are preferably formed in a planar surface of the first plate 200 in order to prevent an internal space from being formed between the first plate and the second plate 300 disposed at positions before and after the first plate when the first and second plates are coupled to the rotational axis 400.

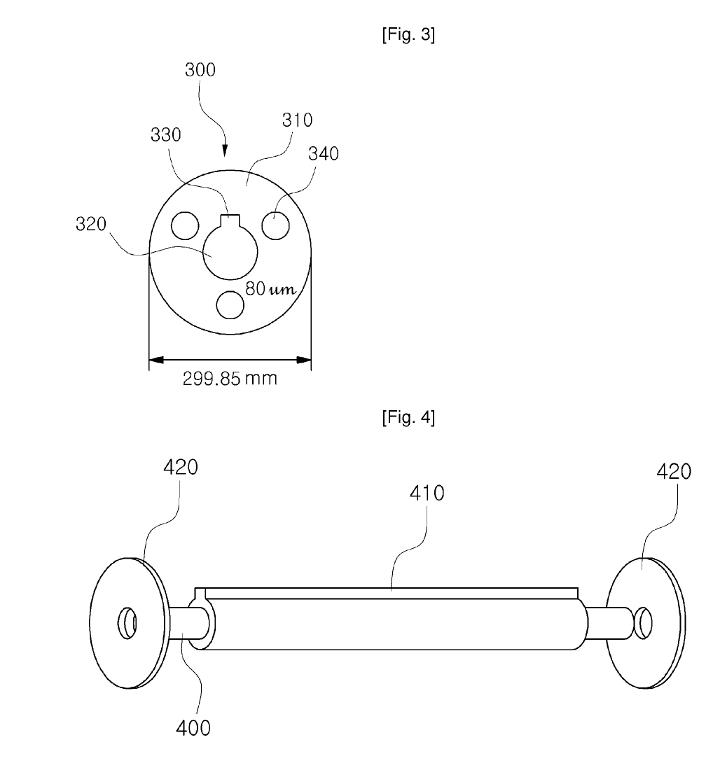

The second plates 300 are composed of a plurality of circular plates 310 having a smaller diameter than the first plate 200, and are alternately stacked on and coupled to the first plates 200 as shown in FIG. 3. In this case, as done in the first plate 200, a penetrating hole 320 for fitting into the rotational axis 400 is formed at a central portion of the circular plate 310 of the second plate 300, and a guiding groove 330 allowing a guiding portion 410 to be easily fitted into the rotational axis is formed at one portion of the penetrating hole. In addition, a plurality of air exhaust holes 340 are also formed for exhausting an internal air between the plates outward.

In this case, the first plate 200 and the second plate 300 are preferably formed of SUS having a superior anti-corrosion property, such a first plate 200 and second plate 300 having different diameters from each other are alternately stacked to form a stepped height between the first plate 200 having a larger diameter and the second plate 300 having a smaller diameter as shown in FIG. 6, and a transparent synthetic resin film 110 surrounding an outer circumferential surface of the first and second plates forms a concave structure along the stepped surface.

In this case, various materials such as polycarbonate (PC), polyethylene terephthalate (PET), or polyvinyl chloride (PVC) may be used for forming the transparent synthetic resin film 110. In addition, a heating unit is also included for applying a heat to allow the synthetic resin film 110 to form a concave structure along the stepped surface between the first plate 200 and the second plate 300, and a cooling unit is also included for cooling a liquid synthetic resin when the liquid synthetic resin is made to flow between the first plate 200 and the second plate 300 to form the concave structure.

Accordingly, in the transparent synthetic resin film 110, a portion in contact with the outer circumferential surface of the first plate 200 having a larger diameter is bent by the difference in diameter between the first and second plates to be filled with a colored ink in a subsequent process to form an opaque layer, and a portion in contact with the outer circumferential surface of the second plate 300 is bent by the difference in diameter between the first and second plates to form a transparent layer 130 around the opaque layer.

In this case, when the first plate 200 has a diameter of 300 mm and the second plate 300 has a diameter of 299.85 mm to cause a difference in diameter of 0.15 mm, a transparent synthetic resin film or a liquid synthetic resin forms as a rectangular wave shape a concave structure with a depth of 0.075 mm which is half the difference in diameter along the stepped surface formed by the difference in diameter. Diameters of the first plate and the second plate may also be variously changed to facilitate formation of the concave structure having various depths.

That is, the diameter of the first plate 200 may be kept while the diameter of the second plate 300 only is changed to 200 mm or 100 mm, so that the depth of the concave structure may be 50 mm or 100 mm corresponding to the difference in radius between the plates.

When the first plate 200 is a circular plate 210 having a thickness of 20 D and the second plate 300 is a circular plate 310 having a thickness of 80 D, an opaque layer having a width of 20 D and the transparent layer 130 having a width of 80 D are alternately formed while forming a rectangular wave shape by means of the first plate 200, which thus forms the concave structure.

Accordingly, the width of the transparent layer may be variously changed from 50 D to 500 D while keeping the width of the opaque layer, so that a securing film having various viewing angles suitable for various uses may be easily manufactured by keeping the width of the first plate 200 at 20 D while varying the width of the second plate 300 from 50 D to 500 D. In addition, the width of the second plate may be kept while the width of the first plate is variously changed so that the width of the opaque layer to be filled with a colored ink may be variously changed.

The rotational axis 400 is fitted into the penetrating holes 220 and 320 of the first plate 200 and the second plate 300 to form the same central axis so that a difference in diameter between the plates becomes the same along the outer circumferential surface of the plates, and a guiding portion 410 protruded on one portion of the outer circumferential surface for guiding the coupling position between the first plate and the second plate is preferably formed on an outer circumferential surface of the rotational axis 400 as shown in FIG. 4.

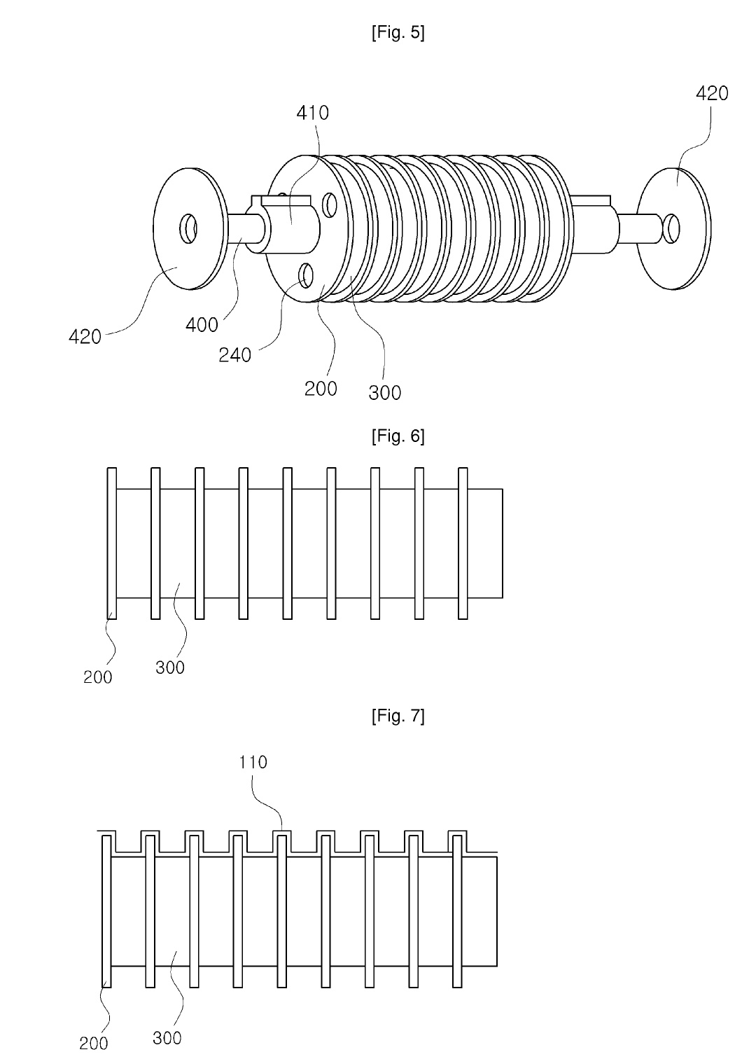

In addition, as shown in FIG. 5, after the first plate 200 and the second plate 300 are alternately and completely fitted, it is preferable to further include a support plate 420 supporting an outermost plate for preventing the plates from being deviated and an internal space between the plates from being formed, and a bolt coupling unit (not shown) for tightly coupling such a support plate to the bolt.

Hereinafter, a configuration of a securing film manufactured by the mold structure according to the present invention as configured above will be described.

As shown in FIG. 9, the securing film 100 is composed of a colored ink layer 120 formed along the difference in diameter between the plates which allows an accurate concave structure of the transparent synthetic resin film to be filled with a colored ink to form an opaque layer, and a transparent layer 130 for coating an outer circumferential surface of the synthetic resin film filled with the colored ink.

The colored ink layer 120 allows a colored ink to flow into a concave structure and to be cooled to uniformly form an opaque layer after a transparent synthetic resin film 110 where the concave structure is formed by the mold structure is separated from the mold structure, wherein the concave structure is formed on an outer circumferential surface of the first plate 200. The transparent layer 130 is formed of a transparent synthetic resin such as PET for coating upper and lower parts of the colored ink layer 120.

Operations of the mold structure for manufacturing the securing film according to the present invention will be then described.

The first plate 200 and the second plate 300 having different diameters from each other are alternately stacked and fitted into the rotational axis 400, the support plate 420 is coupled to the outermost portion of the coupled plates, which is then coupled to a bolt to be tightly fixed. At this time, the first plate and the second plate cause an internal air to be exhausted through air exhaust holes 240 and 340 formed in the circular plates so that the plates are completely and closely adhered to each other.

A transparent synthetic resin film 110 or a liquid synthetic resin such as PC, PET, or PVC is then in contact with an outer circumferential surface of the first plate 200 and the second plates 300 as shown in FIG. 7. At this time, a heat is applied by a heating unit disposed outside of the plates to cause the synthetic resin film 110 to be closely adhered to the stepped surface between the plates to form a concave structure and to cause the liquid synthetic resin closely adhered to the plates by a ventilation fan or a cooling water to be solidified to form a concave structure.

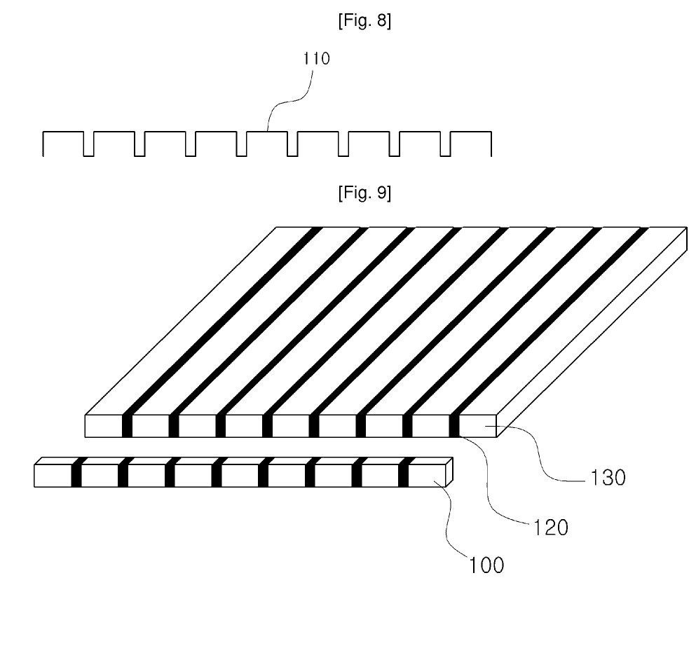

The synthetic resin film 110 is then separated from the first plate 200 and the second plate 300 to manufacture a transparent synthetic resin film 110 where a uniform and accurate concave structure is formed as shown in FIG. 8.

The synthetic resin film 110 having the concave structure is then separated from the mold structure, a colored ink is made to flow into the thin and deep concave structure to form an opaque colored ink layer 120 which shields lights, and upper and lower parts of the synthetic resin film 110 having the colored ink layer 120 are coated with a transparent synthetic resin to manufacture a securing film 100 of which an opaque layer and a viewing angle are accurately controlled. Such a securing film is suitably cut for products of interest to form the securing film 100.

While the invention has been described with reference to preferred embodiments as mentioned above, it will be understood by those of ordinary skill in the art that various changes in form and details may be made therein without departing from the spirit and scope of the present invention as defined by the following claims.

### INDUSTRIAL APPLICABILITY

According to the mold structure for manufacturing a securing film of the present invention, a stepped surface formed by different diameters of two plates is used to form an accurate concave structure in a transparent synthetic resin film, so that the accurate concave structure can be employed with a lower cost for manufacturing an accurate securing film without depending on an expensive exposure etching in order to form an opaque layer required for the securing film.

In addition, According to the mold structure for manufacturing a securing film of the present invention, concave structures having various widths and depths can be formed by only changing thickness and diameter of two plates, which thus can be employed for manufacturing securing films having various sizes and viewing angles.

1. A mold structure for manufacturing a securing film comprising
a plurality of first plates each having a penetrated thin circular plate at its center;
a plurality of second plates each having a smaller diameter than the first plate and being disposed between the first plates, having a transparent synthetic resin film formed in a concave structure where a colored ink layer is to be formed by the first plates protruded outward due to a difference in diameter between the first and second plates, and having penetrated circular thin plates at respective centers; and
a rotational axis fitted into the penetrated portions of the first and second plates.

2. The mold structure for manufacturing a securing film according to claim 1, wherein the rotational axis has a guiding portion protruded on one side of the outer circumferential surface, and a guiding hole corresponding to the shape of the guiding portion may be penetrated at centers of the first and second plates.

3. The mold structure for manufacturing a securing film according to claim 2, wherein the first and second plates have air holes closely adhered to the first and second plates for completely exhausting an internal air between the first and second plates at positions corresponding to each other when the first plate and the second plate are alternately coupled to the rotational axis.

4. The mold structure for manufacturing a securing film according to claim 3, wherein a support plate supporting the outermost plate and for preventing the plate from being deviated, and a bolt coupling unit for coupling the support plate with the bolt are further comprised after the first and second plates are fitted into the rotational axis.

5. The mold structure for manufacturing a securing film according to claim 4, wherein the first and second plates are made from a Steel Use Stainless (SUS).

6. The mold structure for manufacturing a securing film according to claim 5, wherein the first plate may have a diameter of 300 mm and the second plate may have a diameter of 100-299.85 mm so that a depth of the concave structure having the colored print layer may be 0.075-100 mm which is a difference in height between the first and second plates.

7. The mold structure for manufacturing a securing film according to claim 5, wherein the first plate may have a diameter of 20 D, the second plate may have a diameter of 50 to 500 D so that a width of the colored ink layer may be 20 D and a width of the transparent layer may be 50-500 D, which allows various viewing angles to be implemented.
